(19) United States
(12) Patent Application Publication
(10) Pub. No.: US 2017/0113410 A1
(43) Pub. Date: Apr. 27, 2017

(54) APPARATUS AND METHOD FOR MANUFACTURING THREE-DIMENSIONAL OBJECTS

(71) Applicant: FIT AG, LUPBURG (DE)

(72) Inventor: CARL FRUTH, LUPBURG (DE)

(21) Appl. No.: 15/332,082

(22) Filed: Oct. 24, 2016

(30) Foreign Application Priority Data
Oct. 23, 2015 (DE) 10 2015 118 162.2

(51) Int. Cl. B29C 67/00; B33Y 30/00; B33Y 50/02; B33Y 10/00

(52) U.S. Cl. CPC B29C 67/0077; B29C 67/0088; B29C 67/0092; B33Y 10/00; B33Y 30/00; B33Y 50/02; B29K 2105/251

(57) ABSTRACT

An apparatus and a method for manufacturing three-dimensional objects by selective solidification of a build material applied in layers use an insulating element having at least two functional openings to improve the manufacturing process and in particular to optimize heat input. One of the at least two functional openings serves as a material passthrough and another of the at least two functional openings simultaneously serves as a radiation passthrough.

### CROSS-REFERENCE TO RELATED APPLICATION

This application claims the priority, under 35 U.S.C. §119, of German Patent Application DE 10 2015 118 162.2, filed Oct. 23, 2015; the prior application is herewith incorporated by reference in its entirety.

### BACKGROUND OF THE INVENTION

### Field of the Invention

The invention relates to an apparatus and a method for manufacturing three-dimensional objects by selective solidification of a build material applied in layers.

A large number of apparatuses and methods for manufacturing three-dimensional objects by selective solidification of a build material applied in layers are known from the existing art. Laser sintering or selective mask sintering, for example, may be recited in that case. Systems with which a layer manufacturing method of that kind can be carried out are also referred to as “rapid prototyping” systems. Those layer manufacturing methods serve to manufacture components built up in layers from solidifiable material such as resin, plastic, metal, or ceramic, and are used, for example, to produce engineering prototypes. Three-dimensional objects can be manufactured directly from CAD data by using an additive production method.

In a layer manufacturing method of that kind, the objects are built up in layers, i.e. layers of a build material are applied successively over one another. Before application of the respective next layers, those locations in the respective layers which correspond to the object to be manufactured are selectively solidified. Solidification is accomplished, for example, by local heating of a usually powdered layering raw material using a radiation source. An exactly defined object structure of any kind can be generated by controlled introduction of radiation in suitable fashion into the desired regions. The layer thickness is also adjustable. A method of that kind is usable, in particular, for the manufacture of three-dimensional bodies by successively generating multiple thin, individually configured layers.

The build material to be solidified is typically preheated to a temperature that is below the processing temperature. The processing temperature is then attained with the aid of an additional energy input.

In a laser sintering process, for example, a plastic material is preheated to a temperature below the sintering temperature. The energy introduced by the laser then contributes only the differential quantity of heat for fusing the powder particles.

Preheating is accomplished in many cases by heating the build platform.

With that heating “from below,” however, the preheating heat flow decreases as the component height increases, due to losses and the increasing volume of the powder charge.

Other methods also result in an undesired irregular temperature distribution in the build material. That also applies, in particular, to those methods in which preheating is accomplished by heat delivery “from above.” In that case devices that can be intermittently heated are placed above the build layer. Complex systems for controlling the heat curve, and other laborious actions, are used in an attempt to achieve a uniform temperature distribution in the build material to be preheated.

### SUMMARY OF THE INVENTION

It is accordingly an object of the invention to provide an apparatus and a method for manufacturing three-dimensional objects, which overcome the hereinafore-mentioned disadvantages of the heretofore-known apparatuses and methods of this general type, which improve the manufacturing process and which, in particular, optimize heat input.

The advantages and configurations explained below in connection with the apparatus also apply analogously to the method according to the present invention, and vice versa.

The invention proposes no longer pursuing the cycle-timed manufacturing procedure known from the existing art in which, after an application of material, firstly a preheating action and then a selective solidification action occur within one clock cycle before another material application is performed in a subsequent new clock cycle. The invention instead proposes a continuous manufacturing process in which application of the build material, preheating, and selective solidification occur simultaneously by local heating of the build material, specifically at different sites on the same objects to be manufactured or also on different objects simultaneously, if multiple objects are being manufactured on the build platform.

The apparatus according to the present invention encompasses: a build platform, disposed in an X-Y plane, on which at least one three-dimensional object is generated in layers; at least one preheating radiation source for inputting thermal energy into the build material; at least one solidifying radiation source for selective solidification of build material by local heating; and an insulating element at least partly overlying the build platform. The insulating element includes at least two simultaneously usable functional openings, one of the at least two functional openings being embodied as a material passthrough and another of the at least two functional openings being embodied as a radiation passthrough. According to the present invention the apparatus encompasses a number of drive devices for generating mutually independently controllable relative motions in an X and/or Y direction between at least two of the three following components of the apparatus: the build platform, the insulating element, the at least one solidifying radiation source.

The method according to the present invention correspondingly encompasses the steps of: generating the at least one three-dimensional object in layers on a build platform disposed in an X-Y plane; inputting thermal energy into the build material with the aid of the at least one preheating radiation source; locally heating build material with the at least one solidifying radiation source, for the purpose of selective solidification; and simultaneously allowing build material and radiation energy to pass through an insulating element at least partly overlying the build platform, using at least two functional openings. According to the present invention the method encompasses generating, by using a number of drive devices, mutually independently controllable relative motions in an X and/or Y direction between at least two of the three following components of the apparatus: the build platform, the insulating element, the at least one solidifying radiation source.

In contrast to previous apparatuses and methods, with the present invention a heating element largely overlying the build platform, for example in the form of a solid heating plate equipped with heating modules, is no longer needed in order to preheat the build material or for post-heating. Instead, the at least one preheating radiation source, for example in the form of an infrared radiator or another suitable thermal radiator, serves to preheat the built material and for post-heating. The preheating radiation source no longer needs to largely overlie the build platform. It is sufficient if the at least one preheating radiation source is mounted above an insulating element that at least in part overlies the build platform, which element promotes, according to the present invention, the introduction of radiation for preheating or post-heating. The insulating element is thermally insulating and is therefore made entirely or at least in part of a thermally insulating material. Or the insulating element ensures the desired insulating property by way of other measures, for example due to a suitable surface coating. The insulating element is embodied in such a way that in its operating position above the object to be built, it delimits toward the top, in thermally insulating fashion, a space between itself and the object. In other words, the principal function of the insulating element is to form a thermally insulating boundary of the intermediate space with respect to the object. It furthermore promotes heat delivery to the object. This is always effected, however, in conjunction with energy that has already been emitted from a heat source (radiation source). This heat source typically is disposed over the insulating element. The thermal radiation emitted therefrom is merely allowed to pass through to the object, and/or is reflected, by the insulating element. The insulating element is entirely passive, i.e. it does not itself radiate.

It is advantageous with regard to the functionality of the insulating element if the insulating element is physically separate from the heat sources that are used, as is the case in the preferred embodiments of the invention. The insulating element is then disposed so as to be spaced away from the radiation sources and is not part of one of the radiation sources. In other words, the insulating element is then a separate component detached from the radiation sources.

Independently of its insulating function, the insulating element includes at least two simultaneously usable functional openings, the one functional opening serving as a material passthrough and the other functional opening serving as a radiation passthrough. The openings consequently serve on one hand as a coating opening for the application of build material onto the build platform, and on the other hand as a heating opening for preheating or post-heating the build material using thermal radiation emitted from the preheating radiation source, or as an exposure opening for local heating of the build material in order to solidify it. When an insulating element of this kind is moved in suitable fashion relative to the build platform, the application of build material, preheating, and selective solidification can occur simultaneously, i.e. non-cycle-timed, uninterrupted manufacture of the at least one object. In other words, the object or objects are built up continuously, the build rate being determined by the relative motion between the build platform and insulating element. The geometric configuration of the object regions located in the various manufacturing process phases, in particular the spacing of those object regions from one another, is determined by the configuration of the functional openings in the insulating element, in particular by the spacing of those functional openings from one another.

For example, in a first object region the build material in the form of a freshly applied powder charge is being preheated by the insulating element, while in a second object region disposed behind the first object region in the motion direction, a layer n is currently being solidified with the aid of radiation energy passing through an exposure opening. At the same time, in a third object region that is located behind the second object region in the motion direction, post-heating of the build layer n, just previously solidified there, is being performed by the at least one preheating radiation source or by the insulating element interacting with the preheating radiation source, while in a fourth object region located behind the third object region, further build material for a subsequent layer n+1, introduced through a coating opening, is being applied onto the layer n that is already present. The object regions can be regions of one object or also regions of different objects, if multiple objects are disposed on the build platform.

Heat delivery for preheating is effected “from above,” so that the disadvantages of heat delivery through the build platform do not occur. At the same time, heat delivery is preferably accomplished not only intermittently, i.e. not only when the at least one preheating radiation source is located (as in the existing art) above the build layer for a short time, but continuously, this being made possible by the novel continuous working mode, in particular due to the insulating and/or reflecting properties of the insulating element. Optimization of heat input is thereby achieved in a simple fashion. At the same time, the manufacturing process as a whole is improved.

Furthermore, in preferred embodiments of the invention, not only the solidifying radiation source but also the preheating radiation source can be moved, namely in an X and/or Y direction for positioning of the preheating radiation source relative to the insulating element or the build platform, and/or perpendicularly thereto in a Z direction in order to modify the vertical spacing for the purpose of a modified radiating characteristic and/or modifiable temperature control. Preferably the at least one preheating radiation source can moreover have control applied to it in controlled fashion in order to modify the radiation output emitted from it.

Due to the generation of multiple relative motions between the participating components (build platform, insulating element and the at least one solidifying radiation source, and optionally the at least one heating radiation source), the effects over time of the various process conditions in the respective method steps can be optimized and coordinated with one another in a simple and very flexible manner. The manufacturing process as a whole can thereby be further optimized.

A decoupling of the motion of the radiation passthrough from the motion of the solidifying radiation source has proven to be particularly advantageous. In other words, the solidifying radiation source can move over the build platform, or over the build material present thereon, at a different speed from the insulating element.

In particular, when the introduction of radiation energy occurs through the exposure opening in the absence of complete illumination of that opening but when instead a controlled irradiation of the build material disposed beneath that opening occurs within the boundaries of that opening, for example in such a way that a laser heats the build material along a defined trajectory, according to the present invention the solidifying radiation source can move, independently of the motion of the insulating element and thus independently of the motion of the exposure opening, in the opening region furnished by the radiation passthrough, in such a way that the radiation power can be introduced particularly efficiently.

In a preferred embodiment of the invention this is brought about by the fact that the apparatus includes, besides a first drive device for generating a first relative motion in an X and/or Y direction between the build platform and the insulating element, a second drive device for generating a second relative motion in an X and/or Y direction, independent of the first relative motion, between the solidifying radiation source and the insulating element. If necessary, a third drive device is provided for generating an independent relative motion of the preheating radiation source.

For further optimization of the process, especially for particularly efficient introduction of the radiation power for solidification of the build material, the shape, configuration, and/or size of the exposure openings, in particular the slit width in the principal motion direction, for example the X direction, can be adaptable to the respective process or can also be varied during the manufacturing process. What can be achieved thereby is, for example, that the region respectively located directly beneath an illumination opening and not heated by the preheating radiation source or the insulating element is as small as possible. For further optimization, the speed of individual components, in particular the speed of the insulating element and thus of the exposure openings, and/or the speed of the radiation source(s), can be varied during the manufacturing process, in particular can be mutually coordinated.

The present invention furthermore allows the need for a uniform temperature distribution to be eliminated. Since the manufacturing method has made different degrees of progress at different sites, different temperatures at different sites can be advantageous. For example, in one region a preheating temperature can be advantageous in order to prepare the build material for imminent local heating. On the other hand, in an adjacent region, a post-heating temperature that is advantageous for achieving certain properties of the already solidified layer can be present, for example in order to prevent warping.

Since the insulating element is constantly available, a defined inhomogeneous temperature distribution of this kind can be implemented in particularly simple fashion. In an advantageous embodiment of the invention the insulating element includes multiple regions capable of different temperature control. This is achieved, for example, with the aid of multiple mutually independently operable preheating radiation sources.

The preheating radiation sources for furnishing thermal energy are embodied, in particular, in the form of heat sources disposed above the insulating element. At least one of the functional openings is configured as a heating opening for the input of thermal energy into the build material. The heating opening can be a functional opening that already performs another function. For example, a radiation passthrough already serving as an exposure opening can serve at the same time as a heating opening.

An embodiment of the invention in which the insulating element is configured reflectively on its side facing toward the build platform has proven to be particularly advantageous for the transfer of heating energy to the build material. The insulating element then serves as a reflector for diffuse reflection of thermal radiation. It reflects onto the build material the thermal radiation introduced in the direction of the build material by the at least one preheating radiation source, and/or it reflects back onto the build material the thermal radiation introduced into the build material and reflected away from the build material. The insulating element is made for this purpose of a correspondingly reflective material, or the insulating element is equipped, in its underside facing toward the build platform in the operating state, with a layer that diffusely reflects thermal radiation. This layer can have been applied onto the insulating element by using a coating.

It is principally these reflective properties of the insulating element that make it possible to use, instead of an expensive active heating element that more or less overlies the build material, an inexpensive passive insulating element in conjunction with preheating radiation sources disposed above. Due to the insulating properties and reflective properties of the insulating element, the desired thermal input into the build material can be achieved with devices of comparatively simple construction. It is possible in particular, with the aid of the insulating element that overlies the object to be manufactured and is disposed directly over the surface of the object, to maintain the desired temperature of the build material with no need for heating modules in the interior of the insulating element.

Preferably, the insulating element is of substantially plate-shaped and flat configuration. The plate-like shape of the insulating element simultaneously makes possible a particularly simple embodiment of the functional openings. In a preferred embodiment of the invention the insulating element is embodied as a very thin, flat plate.

In a particularly preferred embodiment of the invention the insulating element is embodied as a foil. The physical size of the apparatus can thereby be appreciably reduced. As a result of the decreased weight of a foil as compared with a solid insulating plate, a corresponding drive device of the insulating element can have smaller dimensions. The size and/or configuration of the functional openings in the insulating element can be modified particularly easily, since it is preferably a flexible foil that can be rolled up. The embodiment with a foil is also space-saving. The storage space required for insulating elements is comparatively small, since the insulating elements can be stored in rolled-up fashion. If the insulating element is embodied as a foil, the foil can be of multi-layer construction with a bottom reflecting layer.

Advantageously, the insulating element and build platform are embodied in such a way that they overlie one another over the largest possible area, preferably completely, or can be caused during the manufacturing process to overlie one another over as large an area as possible, preferably completely.

In a preferred embodiment of the invention the insulating element is disposed above the build platform, the insulating element being spaced away from the respectively topmost build layer. Heating is accomplished by thermal radiation.

If the build platform is located inside a process chamber that is closed in the operating state, the insulating element can then serve as a delimiting wall of the process chamber. In other words, in this case the process chamber is closed off by the insulating element. The insulating element is then a part of the process chamber.

The coating opening is always an actual opening in the sense of a material perforation. For the exposure opening and the heating opening, however, the insulating element need not obligatorily be perforated. The exposure opening or heating opening can also be embodied as a region of suitable material, in the basic body of the insulating element, that is suitable for the passage of radiation.

In a preferred embodiment of the invention radiation energy for solidifying the build material is introduced through the exposure opening but that opening is not completely illuminated. Instead, a targeted irradiation of the build material disposed below that opening occurs within the boundaries of that opening. The radiation can derive from one or more solidifying radiation sources. For example, for local heating of the build material one or more laser beams can execute a linear back-and-forth motion inside the functional opening within the window furnished by the functional opening, or the laser beam or beams are guided in defined fashion inside the window on a nonlinear trajectory, in each case as a function of the structure to be generated. The radiation is guided with the aid of a suitable control system. The build material, previously preheated to a temperature below the processing temperature, becomes locally further heated. The processing temperature is reached with the aid of this additional energy input.

In a particularly advantageous embodiment of the invention at least two solidifying radiation sources are used for energy input. The radiation thereof is simultaneously incident through a shared exposure opening onto a region of the build layer located therebeneath and uncovered by that exposure opening. Due to the simultaneous use of multiple solidifying radiation sources, the radiation energy can be introduced particularly efficiently. At the same time, as described below, this makes possible a further optimization of energy delivery.

In a particularly advantageous embodiment of the invention provision is made that each solidifying radiation source has associated with it a region of the build layer to be irradiated by it, hereinafter referred to as a “target region.” Adjacent target regions overlap at least in part, forming an overlap region.

In other words, the at least two simultaneously operated solidifying radiation sources have control applied to them, in particular are moved in an X and/or Y direction, in such a way that they (also) introduce radiation energy into at least one shared area (the overlap region), i.e. an area irradiated by the at least two solidifying radiation sources, of the build layer. The at least two solidifying radiation sources irradiate the overlap region either simultaneously or successively.

Control is preferably applied to the at least two solidifying radiation sources in such a way that the manner in which the radiation regions overlap yields a minimal total processing duration for the build material. More precisely, the time span required for introduction of the energy necessary for solidification of the build material is minimal. The total time span for manufacturing the three-dimensional objects is thereby shortened. Preferably, control is at the same time applied in such a way that the operating times of the individual radiation sources are minimized.

In order to minimize the processing duration, in a preferred embodiment of the invention the areas to be exposed (the target regions) are firstly subdivided into individual sub-regions, hereinafter referred to as “surface segments,” or such surface segments are selected from the respective target region and in that manner are distinguished from sub-regions that do not need to be exposed. The region capable of simultaneous irradiation by multiple solidifying radiation sources and predefined by way of the shape and size of the illumination opening is segmented, for example, in an X and a Y direction.

The necessary dwell time of the individual solidifying radiation sources in the respective surface segment is then calculated. Lastly a suitable (preferably the fastest) exposure strategy is identified, with the paths that the individual radiation sources describe within the window furnished by the radiation passthrough being identified. Energy input is accomplished, for example, by the fact that a laser beam performs a linear line-by-line scan or sweep over the relevant surface region, for example forming closely adjacent straight hatching lines, in order to solidify a region of the build layer. This exposure pattern can vary from one layer to another.

Preferably, not only is the exposure strategy for a specific segmentation identified from the standpoint of time-related optimization of the manufacturing process, but the segmentation itself is also carried out in such a way that subsequent exposure can be accomplished particularly efficiently. For example, segmentation is accomplished in consideration of the location of the motion axes of the radiation sources.

A suitable preheating strategy in terms of the individual surface segments is preferably also identified and carried out, “preheating” and “preheating strategy” also being intended to refer to any post-heating, i.e. the application of thermal energy onto build material that is already solidified.

The apparatus according to the present invention for manufacturing three-dimensional objects encompasses suitable devices for segmenting, for calculating the dwell time, and for identifying the exposure strategy and/or preheating strategy, or is connected to such devices or obtains corresponding information, in particular control data for applying control to the number of radiation sources for implementing the identified exposure strategy and/or preheating strategy, from an external data source.

The control data used to control the apparatus according to the present invention encompass a data model for describing the objects to be manufactured, or are generated with the use of such a data model. The data model describes not only the division of each object into build layers, but also the location of the objects on the build platform.

With the aid of the present invention it is possible for the data model on which manufacture of the three-dimensional objects is based to be optimized in such a way that the configuration of the objects on the build platform, or the location of the objects with respect to one another, is selected so that particularly efficient manufacture, especially particularly rapid manufacture, is accomplished in consideration of the exposure strategy or preheating strategy. In a particularly advantageous embodiment of the invention what is effected is therefore not only an optimum selection of the respective individual exposure strategy or preheating strategy for each build layer, in particular an optimization of the radiation input over time, but also, even before that, an optimization, in consideration of the method according to the present invention, of the configuration on the build platform of the objects to be manufactured.

In a simple variant of the invention the configuration and the size of the functional openings are unmodifiable. It has proven advantageous, for example, to use strip-shaped functional openings that lie parallel to one another. The functional openings are advantageously disposed in the insulating element perpendicularly to the direction of relative motion, for example perpendicularly to the X direction or Y direction. Alternatively, it is possible for the functional openings to be disposed obliquely, i.e. at an angle to the motion direction. It is advantageous in the context of the present invention that the shape, configuration, and size of the functional openings can be adapted to the special aspects of the method. Instead of strip-shaped or slit-shaped functional openings, for example, orifice-shaped functional openings or functional openings of any other shape can also be provided for all or for individual functions.

In an advantageous embodiment of the invention the shape, configuration, and/or size of the functional openings are modifiable. For example, it can be advantageous to embody the size of the exposure opening modifiably, in particular when the functional opening serves as an aperture stop, i.e. serves to delimit the cross section of the introduced radiation. It can likewise be advantageous to embody the size of the coating opening modifiably, in particular when the shape and/or size of that opening directly determine the application location or the volume of build material applied per unit time. A modification of the functional openings can also be effected in particular during runtime, i.e. while the manufacturing process is in progress. Additional suitable drive and control devices are then to be provided for this as applicable.

In variant embodiments of the invention the nature and configuration, in particular the sequence, of the functional openings can be modified and adapted to different working methods and operating modes. In a preferred embodiment of the invention, for example, a material passthrough can be flanked by two radiation passthroughs, thus enabling bidirectional coating and exposure. Radiation delivery for solidification of the build material can be accomplished independently of the direction of the relative motion between the build platform and insulating element, in particular in the context of both forward and reverse motion. The elevated build rate thereby achievable is advantageous.

In a further preferred embodiment of the invention, provision is made that the insulating element is not stationary but instead moves relative to the build platform, and that the at least one solidifying radiation source co-moves along with the insulating element, more precisely with the exposure opening associated therewith. Provision can be made in this context that the relative position of the solidifying radiation source and insulating element with respect to one another remains unchanged. In the context of suitable control application and a correspondingly configured drive device, however, provision can also be made that the relative position between a solidifying radiation source and the insulating element can be modified in controlled fashion, in particular in conjunction with a previously ascertained exposure strategy, the insulating element either being stationary or also moving. The number of solidifying radiation sources can likewise be adapted to the desired exposure strategy. In a preferred embodiment, for example, a single exposure opening has associated with it several solidifying radiation sources co-moving with the exposure opening.

It is not only heat input into the build material that is improved with the present invention. In addition, the manufacturing process can also be carried out particularly efficiently due to a suitable interaction of the configuration and size of the functional openings and the relative motion between the insulating element and build platform, and the manner in which the preheating radiation and/or the radiation for local solidification of the build material is furnished and/or guided.

This purpose is served by a central control system for the manufacturing process using a data model for description of the object to be manufactured with the aid of the layer building method. The control system encompasses all relevant operations of the manufacturing process which proceeds simultaneously at multiple sites in different manufacturing phases, i.e. a manufacturing process that has made different degrees of progress. In other words, control always occurs in accordance with the actual progress of the manufacturing process, using for this purpose sensor data of suitable sensors, in particular temperature sensors. The control system encompasses, in particular, control of the preheating radiation sources for temperature control of the build material, in this case (optionally) defined control of individual temperature regions in interaction with the insulating element. The control system also encompasses control of the drive devices for the relative motions between the insulating element, the build platform, and/or the radiation source(s), i.e. also control of the guided radiation sources(s) for warming or for local heating of the build material, and control of the furnishing device and/or application device for furnishing and/or applying the build material as well as also, if applicable, control of the functional openings having a configuration and/or size which are modifiable.

All calculation operations necessary in connection with control of the layer manufacturing system and with execution of the method according to the present invention are performed by one or more data processing units that are embodied to carry out those operations. Each of these data processing units preferably has a number of functional modules, each functional module being configured to carry out a specific function or a number of specific functions in accordance with the method described. The functional modules can be hardware modules or software modules. In other words, insofar as it relates to the data processing unit the invention can be realized either in the form of computer hardware or in the form of computer software, or as a combination of hardware and software. If the invention is realized in the form of software, i.e. as a computer program product, all of the functions described are implemented by computer program instructions when the computer program is executed on a computer having a processor. The computer program instructions are realized in any programming language in a manner that is known per se, and can be furnished to the computer in any form, for example in the form of data packets that are transferred through a computer network, or in the form of a computer program product stored on a diskette, on a CD-ROM, or on another data medium.

Other features which are considered as characteristic for the invention are set forth in the appended claims.

Although the invention is illustrated and described herein as embodied in an apparatus and a method for manufacturing three-dimensional objects, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram illustrating an apparatus according to the present invention having a highly simplified, diagrammatically-illustrated process chamber shown in section;

FIG. 2 is a diagrammatic plan view illustrating an insulating element disposed over a build platform;

FIG. 3 shows simplified sectional illustrations of layers of the object to be built up, in different manufacturing phases;

FIG. 4 is a perspective view of an embodiment of the invention having two radiation sources; and

FIG. 5 is a simplified diagrammatic, sectional illustration of the apparatus according to the present invention having alternative functional openings.

### DETAILED DESCRIPTION OF THE INVENTION

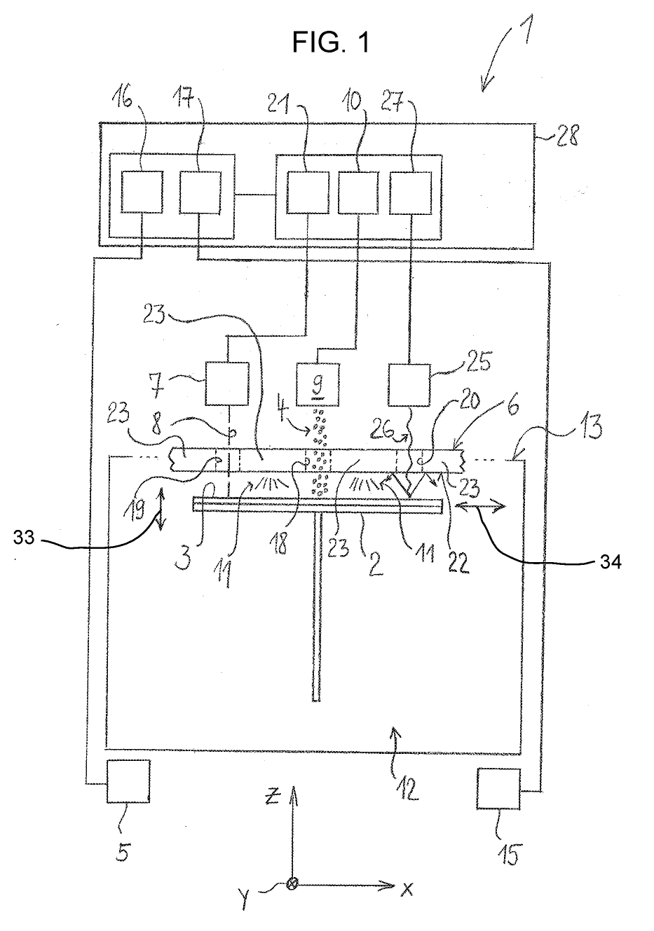

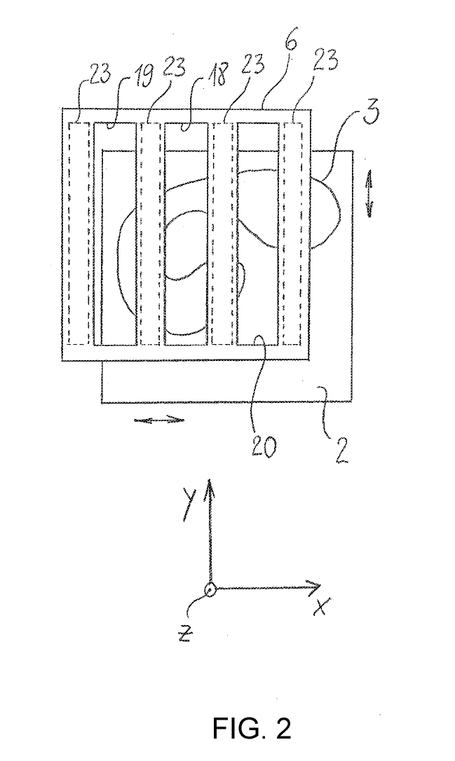

Referring now in detail to the figures of the drawings, which are not to scale, are merely diagrammatic, only include important constituents and in which identical reference characters correspond to elements having an identical or comparable function, and first, particularly, to FIGS. 1 and 2 thereof, there is seen an apparatus 1 for laser sintering which is described by way of example, as an apparatus for manufacturing at least one three-dimensional object by selective solidification of a build material applied in layers. The invention is not, however, limited to this specific method. The invention is also applicable to other additive production methods, for example laser melting, mask sintering, drop on powder/drop on bed, stereolithography, and the like.

An orthogonal coordinate system (X, Y, Z) is utilized in the description of the invention.

The apparatus 1 for laser sintering encompasses a build platform 2, disposed in an X-Y plane, on which a three-dimensional object 3 is generated in layers in a known fashion. A build material 4 is a suitable plastic powder. After production of a layer n, in order to produce a new layer n+1 the build platform 2 having the already created and hardened layers is displaced downward over a specific travel length. This purpose is served by a drive device 5 for generating a relative motion in a Z direction, i.e. perpendicularly to the build plane, between the build platform 3 and an insulating element 6 described later in further detail. This motion in a Z direction is indicated in FIG. 1 by an arrow 33. The drive device 5 is, for example, an electric motor.

Between solidification of a layer n and application of new build material 4 for a subsequent layer n+1, provision can be made to remove excess build material 4 from the build platform 2. In this case a non-illustrated device suitable for this purpose is provided, for example in the form of a wiping blade or the like, which advantageously is connected to or interacts with the insulating element 6.

The apparatus 1 encompasses at least one solidifying radiation source 7 that furnishes radiation energy for local heating of the build material 4 in order to selectively solidify the latter. The at least one radiation source 7 is, for example, a laser that delivers a laser beam 8 in guided fashion.

The apparatus 1 furthermore encompasses at least one furnishing and/or application device 9 with which build material 4 is furnished and/or is applied onto the build platform 2 or onto a build layer that is already present. The furnishing and/or application device 9 is, for example, a device for applying a powder charge. The furnishing and/or application device 9 is connected to a corresponding control system 10 that controls the application of material.

The apparatus 1 further encompasses the insulating element 6 (already mentioned above) which continuously at least partly overlies the build platform 2 during the manufacturing process. The insulating element 6 is a flexible foil made entirely of a thermally insulating material and extending substantially in the X-Y plane. It is disposed above the build platform 2, being spaced away from the respectively topmost build layer. The spacing is typically between 100 μm and 10 mm. An underside 22, facing toward the build platform 2, of the insulating element 6 is embodied in such a way that it reflects thermal radiation diffusely toward the build material and the object to be built.

The apparatus 1 encompasses a preheating radiation source 25, serving to preheat the build material and being disposed above the insulating element 6, for furnishing thermal energy. This radiation source 25 is, for example, an infrared radiator that emits infrared radiation 26. A suitable control system 27 is provided for this radiation source 25.

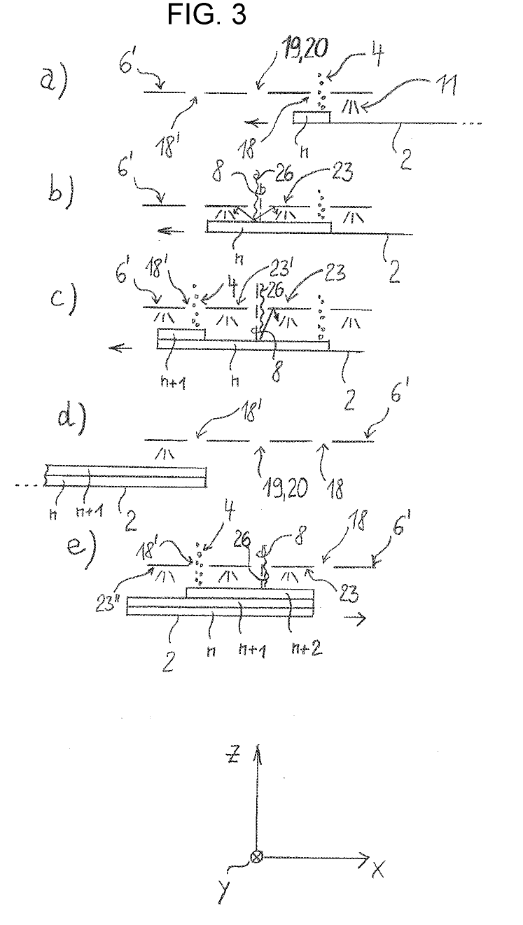

Associated with the radiation source 25 is at least one dedicated functional opening 20 that thereby serves as a heating opening. The radiation source 25 can, however, also have associated with it one or more of the other functional openings (described in more detail below), for example an exposure opening, which thus simultaneously serves as a heating opening. Heating of the build material 4 is accomplished by the infrared radiation 26 emitted from the radiation source 25 through the heating openings 20 in the insulating element 6, and by thermal radiation 11 reflected from the underside 22 of the insulating element 6, as depicted symbolically in FIGS. 1 and 3.

The build platform 2 is located inside a process chamber 12, which is closed in the operating state and is only diagrammatically indicated in FIG. 1. The insulating element 6 serves in this case as a delimiting wall of process chamber 12. More precisely, the insulating element 6 is embodied as a part of an upper cover 13 of the process chamber 12.

The apparatus 1 further encompasses a drive device 15 for generating a relative motion between the build platform 2 and the insulating element 6 in an X and/or Y direction, i.e. in a layer direction. This motion in an X and/or Y direction is indicated in FIG. 1 by an arrow 34. The drive device 15 is, for example, an electric motor. The two drive devices 5, 15 are connected to corresponding drive control systems 16, 17.

In the exemplary embodiment described herein, the drive device 15 moves the build platform 2 relative to the stationary insulating element 6. The principal motion direction is the X direction. In the simplest case, the motion of the build platform 2 is limited to this principal motion direction. If it is necessary or advantageous for the manufacturing process, the motion in an X direction can be overlaid by a motion of build platform 2 in a Y direction.

In an exemplary embodiment that is not depicted, the radiation source 25 also can be equipped with a drive device, in particular in order to move the radiation source in an X and/or Y direction, preferably also independently of one of the other above-described motions of the insulating element 6 and the build platform 2. A further drive device of this kind can also be an electric motor that is connected to a corresponding drive control system. In the simplest case, however, the radiation source 25 is disposed in a stationary fashion with respect to the insulating element 6. In those cases, in which the insulating element 6 is not stationary but instead is moved in an X and/or Y direction, the radiation source 25 is then co-moved by the corresponding drive device along with the insulating element 6.

The insulating element 6 includes at least two, in the example depicted in FIG. 1 three, simultaneously usable functional openings 18, 19, 20 spaced apart from one another. The functional openings 18, 19, 20 are slit-shaped or strip-shaped, elongatedly rectangular, and lie parallel to one another and perpendicular to the principal motion direction, in this case the X direction. One of the functional openings is embodied as a material passthrough 18 and another of the functional openings as a radiation passthrough 19, while the third functional opening serves as heating opening 20. During the production of the object 3, both the build material 4 and the radiation energy for heating the build material, as well as radiation energy for solidifying the build material, in this case in the form of the laser beam 8, are allowed to pass simultaneously through the functional openings 18, 19, 20.

Expressed differently, the one functional opening is configured as a coating opening 18 for the application of the build material 4 onto the build platform 2 or onto a build layer that is already present, and the other functional opening is embodied as an exposure opening 19 for simultaneous introduction of radiation energy of the at least one radiation source 7 into the applied build material 4 in order to solidify the build material 4.

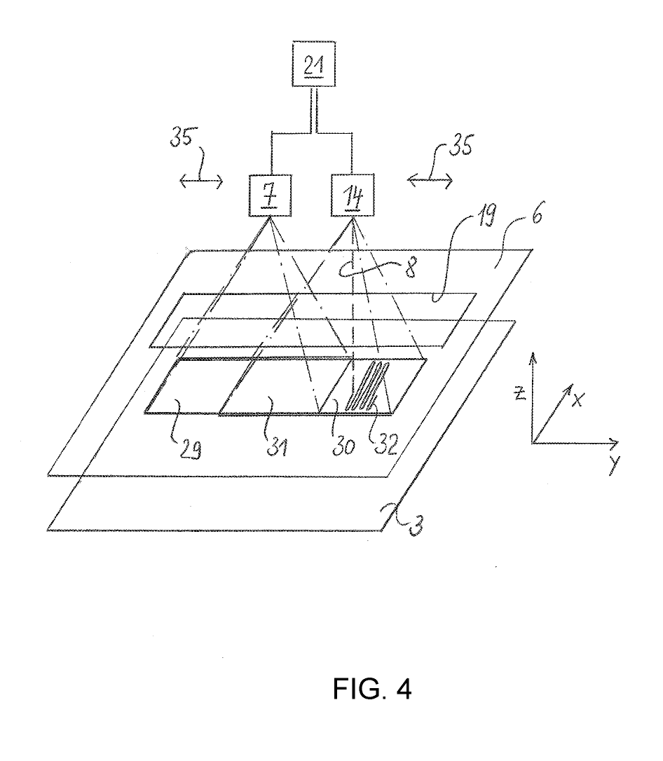

The radiation energy for local heating of the build material 4 is introduced by guiding the laser beam 8 through the exposure opening 19 on a defined path. The laser beam 8 is guided with the aid of a suitable drive and control device 21. In other words, not only is the first drive device 15 used to generate a relative motion in an X and/or Y direction between the build platform 2 and the insulating element 6, but a second drive device 21 is also used to generate a second relative motion in an X and/or Y direction, independent of the first relative motion, between the radiation source 7 and the insulating element 6. In the illustrated example, the second drive device 21 serves to move the radiation source 7. This motion of the radiation source 7 in an X and/or Y direction is indicated in FIG. 4 by arrows 35.

Instead of a stationary insulating element 6 having a build platform and a radiation source 7 that are movable with respect thereto, in alternative embodiments (not illustrated) the build platform can also be stationary in the X-Y plane. In this case the insulating element 6 and the radiation source 7 are embodied movably with respect to one another. Alternatively, a stationary radiation source 7 can also be combined with a moving insulating element 6 and a moving build platform 2 in order to furnish the two desired relative motions. The radiation source 7 can also be co-moved along with the insulating element 6 so that their mutual relative positions do not change. The apparatus 1 can also include a third drive device (not depicted) for generating a relative motion between the solidifying radiation source 7 and the insulating element 6 in an X and/or Y direction, as well as a drive control system pertinent thereto, with the third drive device preferably driving the solidifying radiation source 7.

The radiation source 25 is provided in order to heat the build material. In an advantageous embodiment of the invention, however, multiple radiation sources 25, to which control can be applied mutually independently, are used. They are disposed above the insulating element 6, in particular exactly over the functional openings, in particular over the heating openings 20. The radiation sources 25 can also, however, be disposed over the exposure openings 19 or the coating openings 18 if provision is also made to introduce thermal radiation through such openings in order to preheat or post-heat the build material. All of the radiation sources 25 are connected to the heating control system 27 that preferably is functionally coupled to the drive device of radiation source 25 when a drive device of this kind is utilized.

A central control system 28 is responsible for controlled execution of the manufacturing method. The control system 28 encompasses all of the relevant control sub-systems 10, 16, 17, 21, 27 for this purpose.

Various phases of manufacture will be described below with reference to FIG. 3. What is used in this case is an insulating element 6′, which is different from the insulating element 6 shown in FIGS. 1 and 2. The insulating element 6′ possesses three functional openings, namely two coating openings 18, 18′ and one exposure opening 19 simultaneously serving as a heating opening 20 and being disposed between the coating openings 18, 18′.

In FIG. 3a, the build platform 2, which is driven by the drive device 15, moves through in an X direction beneath the first coating opening 18 of the insulating element 6. The build material 4 for a layer n becomes deposited onto the build platform 2.

In FIG. 3b, the build platform 2 moves farther in an X direction. The build material 4 that was applied shortly beforehand becomes preheated to a temperature below the sintering temperature. The thermal radiation 26 is radiated for this purpose from the radiation source 25 toward the build material. The thermal radiation 26 traverses the insulating element 6 through the exposure and heating opening 19, 20 and is irradiated directly into the build material in the region of that opening. The thermal radiation 26 is simultaneously introduced into the build material as reflected thermal radiation 11 from the reflective underside 22 of the insulating element, in a reflective region 23 between the first coating opening 18 and the exposure and heating opening 19, 20. At the same time, in an adjacent object region preheated just previously, additional thermal energy is introduced with the aid of laser beam 8 through the exposure opening 19, with the result that the powder particles fuse.

In FIG. 3c, the build platform 2 moves farther in an X direction. Before the build platform 2 reaches the second coating opening 18′, it is moved a requisite travel distance downward in the Z direction, driven by the drive device 5. The build material 4 for a further layer n+1 is applied through the second coating opening 18′. The object region below a reflective region 23′, located between the exposure opening 19 and the second coating opening 18′, had just previously been heated again by irradiated and reflected thermal radiation 11.

In FIG. 3d, the build platform 2 has reached its one reversal point. The layers n and n+1 have been generated. Since there is no longer an exposure and heating opening 19, 20 located above the build platform 2, at this moment laser irradiation is no longer taking place. The application of build material 4 also occurs only as long as at least one of the two coating openings 18, 18′ is disposed above the build platform 2.

In FIG. 3e, the build platform 2 moves through beneath the insulating element 6 in an X direction, oppositely to the first motion. With the aid of the second coating opening 18′, a new application of material for the next layer n+2 has already occurred, as has preheating of the build material with the aid of irradiated and reflected thermal radiation 11 in an object region below a reflective region 23″ adjacent the coating opening 18′. The build platform 2, driven by the drive device 5, has previously been moved down again a necessary distance in the Z direction. A local irradiation with the laser beam 8 occurs through the exposure and heating opening 19, 20 in order to solidify the structure to be generated. Post-heating occurs in the first reflective region 23 as a result of irradiated and reflected thermal radiation 11. Upon a further motion of the build platform 2, an application of material for a layer n+3 will occur shortly through first coating opening 18.

FIG. 4 illustrates an exemplary embodiment in which radiation 8 from two simultaneously operated radiation sources 7, 14 is incident, through a shared exposure opening 19, onto a build layer 3 uncovered by that exposure opening 19. For reasons of clarity, the insulating element 6 is depicted as being transparent. In addition, only a single functional opening (exposure opening 19) is illustrated. Each radiation source 7, 14 has a target region 29, 30 associated with it, this association being depicted symbolically with dashed auxiliary lines. The two target regions 29, 30 intersect one another forming an overlap region 31. Control is applied to the at least two radiation sources 7, 14, which again can be lasers, by way of a correspondingly embodied drive and control device 21, so as to result in a minimum total processing duration for the build material. In order to bring about an optimum exposure structure, each radiation source 7, 14 moves on a defined path 32 in an X and/or Y direction, as is indicated for the radiation source 14 in FIG. 4.

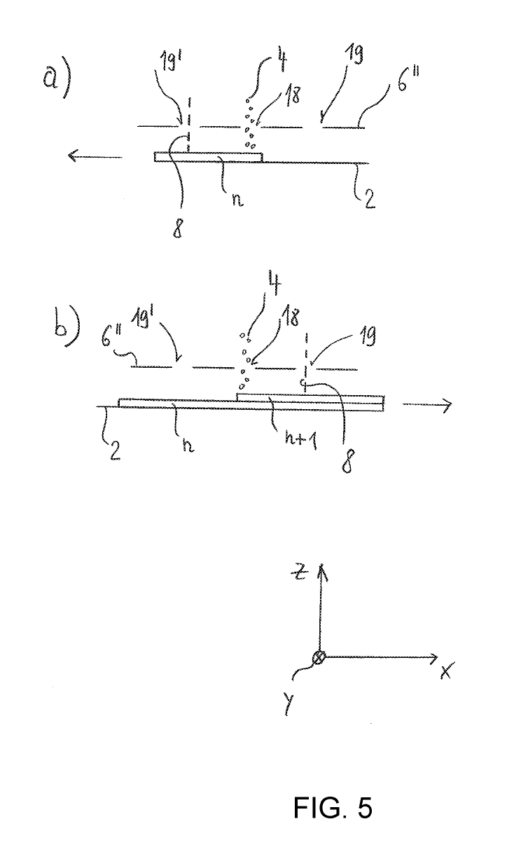

In an alternative variant of an insulating element 6″ depicted in FIG. 5, a coating opening 18 is provided between two exposure openings 19, 19′. Bidirectional exposure is thereby enabled by the fact that upon a motion of the build platform 2 in an X direction after a material deposition of a layer n through the coating opening 18, an exposure occurs through the exposure opening 19 located behind the coating opening 18 in a motion direction (FIG. 5a). Conversely, upon a reverse motion of the build platform 2 oppositely to the X direction, exposure of the next layer n+1 is already taking place through the exposure opening 19′ that is then located behind the coating opening 18 in a motion direction, of material having previously been applied through the coating opening 18 (FIG. 5b).

All of the features presented in the specification, in the claims below, and in the drawings can be important to the invention both individually and in any combination with one another.

1. An apparatus for manufacturing three-dimensional objects by selective solidification of a build material applied in layers, the apparatus comprising:
a build platform disposed in an X-Y plane, said build platform being configured to have at least one three-dimensional object generated in layers on said build platform;
at least one preheating radiation source for inputting thermal energy into the build material;
at least one solidifying radiation source for selective solidification of the build material by local heating;
an insulating element at least partly overlying said build platform, said insulating element having at least two simultaneously usable functional openings formed therein, one of said at least two functional openings being formed as a material passthrough and another of said at least two functional openings being formed as a radiation passthrough; and
a plurality of drive devices for generating relative motions in at least one of an X or Y direction between at least two of the following: said build platform, said insulating element and said at least one solidifying radiation source.

2. The apparatus according to claim 1, wherein said insulating element has a reflectively-configured side facing toward said build platform.

3. The apparatus according to claim 1, wherein said insulating element is a foil.

4. The apparatus according to claim 1, wherein said plurality of drive devices include:
a first drive device for generating a relative motion in at least one of an X or Y direction between said build platform and said insulating element; and
a second drive device for generating a relative motion in at least one of an X or Y direction between said at least one solidifying radiation source and said insulating element.

5. The apparatus according to claim 1, wherein:
said at least one solidifying radiation source includes at least two simultaneously operable solidifying radiation sources; and
a control system applies control to said solidifying radiation sources to cause radiation regions of said solidifying radiation sources to overlap.

6. The apparatus according to claim 1, wherein said functional openings have at least one of a shape, a configuration or a size being modifiable.

7. The apparatus according to claim 1, wherein at least one of said insulating element or said at least one solidifying radiation source has a speed being modifiable during a manufacturing process.

8. The apparatus according to claim 1, wherein one of said functional openings is configured as a material passthrough and two of said functional openings flanking said one functional opening laterally in a motion direction are configured as radiation passthroughs.

9. The apparatus according to claim 4, which further comprises a third drive device for generating a relative motion in at least one of an X or Y direction between said at least one solidifying radiation source and said insulating element.

10. A method for manufacturing three-dimensional objects by selective solidification of a build material applied in layers, the method comprising the following steps:
generating at least one three-dimensional object in layers on a build platform disposed in an X-Y plane;
inputting thermal energy from at least one preheating radiation source into the build material;
locally heating build material using at least one solidifying radiation source for selective solidification;
simultaneously guiding the build material and radiation energy through at least two functional openings in an insulating element at least partly overlying the build platform; and
using a plurality of drive devices to generate relative motions in at least one of an X or Y direction between at least two of the following: the build platform, the insulating element and the at least one solidifying radiation source.
